(19) United States
(12) Patent Application Publication
(10) Pub. No.: US 2025/0247908 A1
(43) Pub. Date: Jul. 31, 2025

(54) TECHNIQUES FOR DETECTING HIGH MOBILITY AND ENHANCING MODEM PERFORMANCE

(71) Applicant: QUALCOMM INCORPORATED, San Diego, CA (US)

(72) Inventors: Xuqiang Zhang, Beijing (CN); Arvind Vardarajan Santhanam, San Diego, CA (US); Jie Mao, Beijing (CN); Nanrun Wu, Beijing (CN); Tom Chin, San Diego, CA (US); Wei-Jei Song, San Diego, CA (US); Jiaheng Liu, Shanghai (CN); Fei Liang, Shanghai (CN); Liang Hong, Beijing (CN); Zhongyue Lou, Beijing (CN); Jiming Guo, Beijing (CN); Peng Hu, Beijing (CN); Xianwei Zhu, Beijing (CN); Xiaochen Chen, Beijing (CN); Jun Deng, Shanghai (CN); Hewu Gu, Shanghai (CN); Kuo-Chun Lee, San Diego, CA (US); Rajeev Pal, San Diego, CA (US)

(21) Appl. No.: 18/833,803

(22) PCT Filed: Mar. 10, 2022
(86) PCT No.: PCT/CN2022/080081

§ 371 Date: Jul. 26, 2024

(51) Int. Cl. H04W 76/15; H04W 36/08; H04W 56/00; H04W 64/00; H04W 84/00

(52) U.S. Cl. CPC H04W 76/15; H04W 36/08; H04W 56/0015; H04W 64/00; H04W 84/005

(57) ABSTRACT

Methods, systems, and devices for wireless communications are described. A user equipment (UE) may detect one or more triggering conditions indicating that the UE is traveling along the route, and should enter the high mobility operating mode to improve mobility procedure performance or processor performance. Upon entering the high mobility operating mode, the UE may perform mobility procedures, handover procedures, cell selection or reselection, or connection procedures. For example, the UE may determine which cell it is approaching, and which cell it is leaving, along the route, which may allow the UE to avoid being assigned to handover to a cell that it is leaving, prioritize or deprioritize measurement reports for UEs that the UE is leaving or approaching, update the contents or timing of measurement reporting, or the like.

### CROSS REFERENCE

The present Application is a 371 national stage filing of International PCT Application No. PCT/CNYYYY/xxxxxx by INVENTOR et al. entitled “TITLE,” filed MM DD, YYYY; and claims priority to International Patent Application No. PCT/CNYYYY/xxxxxx by INVENTOR et al. entitled “TITLE,” filed MM DD, YYYY, each of which is assigned to the assignee hereof, and each of which is expressly incorporated by reference in its entirety herein.

### FIELD OF TECHNOLOGY

The following relates to wireless communications, including techniques for detecting high mobility and enhancing modem performance.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for detecting high mobility and enhancing modem performance. A user equipment (UE) may detect one or more triggering conditions indicating that the UE is traveling along the route, and should enter the high mobility operating mode to improve mobility procedure performance or processor performance. Upon entering the high mobility operating mode, the UE may perform mobility procedures, handover procedures, cell selection or reselection, or connection procedures. For example, the UE may determine which cell it is approaching, and which cell it is leaving, along the route, which may allow the UE to avoid being assigned to handover to a cell that it is leaving, prioritize or deprioritize measurement reports for UEs that the UE is leaving or approaching, update the contents or timing of measurement reporting, or the like.

A method for wireless communications at a user equipment (UE) is described. The method may include detecting one or more triggering conditions associated with travel along a route corresponding to a set of multiple network entities, switching from a default operating mode to a high mobility operating mode based on detecting the one or more triggering conditions, and performing at least one mobility operation including a handover procedure, a neighbor cell reselection procedure, a measurement reporting procedure, or a connection procedure, according to the high mobility operating mode.

An apparatus for wireless communications at a UE is described. The apparatus may include a processor, memory coupled with the processor, and instructions stored in the memory. The instructions may be executable by the processor to cause the apparatus to detect one or more triggering conditions associated with travel along a route corresponding to a set of multiple network entities, switch from a default operating mode to a high mobility operating mode based on detecting the one or more triggering conditions, and perform at least one mobility operation including a handover procedure, a neighbor cell reselection procedure, a measurement reporting procedure, or a connection procedure, according to the high mobility operating mode.

Another apparatus for wireless communications at a UE is described. The apparatus may include means for detecting one or more triggering conditions associated with travel along a route corresponding to a set of multiple network entities, means for switching from a default operating mode to a high mobility operating mode based on detecting the one or more triggering conditions, and means for performing at least one mobility operation including a handover procedure, a neighbor cell reselection procedure, a measurement reporting procedure, or a connection procedure, according to the high mobility operating mode.

A non-transitory computer-readable medium storing code for wireless communications at a UE is described. The code may include instructions executable by a processor to detect one or more triggering conditions associated with travel along a route corresponding to a set of multiple network entities, switch from a default operating mode to a high mobility operating mode based on detecting the one or more triggering conditions, and perform at least one mobility operation including a handover procedure, a neighbor cell reselection procedure, a measurement reporting procedure, or a connection procedure, according to the high mobility operating mode.

In some examples of the method, apparatuses, and non-transitory computer-readable medium described herein, detecting the one or more triggering conditions may include operations, features, means, or instructions for accessing an entrance to the route via an application executed by the UE, where the route includes a subway route, a high-speed train route, a freeway route, or a combination thereof.

In some examples of the method, apparatuses, and non-transitory computer-readable medium described herein, detecting the one or triggering conditions may include operations, features, means, or instructions for connecting to a wireless local area network associated with the route.

In some examples of the method, apparatuses, and non-transitory computer-readable medium described herein, detecting the one or more triggering conditions may include operations, features, means, or instructions for detecting a sensor input indicating that the UE may be located on the route, within a vehicle associated with the route, or both.

In some examples of the method, apparatuses, and non-transitory computer-readable medium described herein, the sensor input may include operations, features, means, or instructions for a pressure measurement associated with train car door opening or closing, a pressure measurement associated with entering an underground train station, a motion sensor measurement indicating a vibration pattern, a camera input indicating a lighting environment associated with a train car or train station, a microphone input indicating an acoustic pattern associated with the train car or train station, a magnetic sensor measurement indicating high mobility on a train or subway, a global positioning system (GPS) input indication a location along the route, a GPS signal strength that satisfies a threshold signal strength level, or any combination thereof.

In some examples of the method, apparatuses, and non-transitory computer-readable medium described herein, detecting the one or more triggering conditions may include operations, features, means, or instructions for detecting a change in reference signal receive power (RSRP) that satisfies a threshold.

Some examples of the method, apparatuses, and non-transitory computer-readable medium described herein may further include operations, features, means, or instructions for communicating with one or more respective network entities of the set of multiple network entities one or more times during a time period, confirming an accuracy level of a cell map including information associated with the set of multiple network entities based on traveling along the route and communicating with the set of multiple network entities at least a threshold number of times, and establishing a connection with a first network entity of the set of multiple network entities, where detecting the one or more triggering conditions includes determining that the first network entity may be associated with the cell map.

Some examples of the method, apparatuses, and non-transitory computer-readable medium described herein may further include operations, features, means, or instructions for establishing one or more connections with respective network entities of the set of multiple network entities one or more times during a time period, submitting an indication of the respective network entities of the set of multiple network entities to a cloud server, receiving, from the cloud server based on submitting the indication of the respective network entities and a current location of the UE within the route, an indication of a cell map including information associated with the set of multiple network entities, and establishing a connection with a first network entity of the set of multiple network entities, where detecting the one or more triggering conditions includes determining that the first network entity may be associated with the cell map.

Some examples of the method, apparatuses, and non-transitory computer-readable medium described herein may further include operations, features, means, or instructions for determining that the UE may be approaching a first network entity of the set of multiple network entities, where performing the at least one mobility operation may be based on the determining.

Some examples of the method, apparatuses, and non-transitory computer-readable medium described herein may further include operations, features, means, or instructions for receiving a synchronization signal block from the first network entity prior to expiration of a synchronization signal block periodicity by a timing offset, where the determining may be based on the receiving.

Some examples of the method, apparatuses, and non-transitory computer-readable medium described herein may further include operations, features, means, or instructions for detecting a positive Doppler shift based on a frequency tracking loop, where the determining may be based on detecting the positive Doppler shift.

Some examples of the method, apparatuses, and non-transitory computer-readable medium described herein may further include operations, features, means, or instructions for transmitting a measurement reporting including an indication of a detected timing offset at which the UE received a synchronization signal block from the first network entity, a detected Doppler shift, or both, receiving, from a second network entity, a reconfiguration message including an indication with the first network entity, where determining that the UE may be approaching the first network entity may be based on the reconfiguration message, and performing the handover procedure with the first network entity based on the reconfiguration message, where the at least one mobility operation includes the handover procedure.

Some examples of the method, apparatuses, and non-transitory computer-readable medium described herein may further include operations, features, means, or instructions for building a cell map including information associated with the set of multiple network entities based on communicating with respective network entities of the set of multiple network entities and determining a moving direction along the route based on the cell map, where determining that the UE may be approaching the first network entity may be based on the moving direction and the cell map.

Some examples of the method, apparatuses, and non-transitory computer-readable medium described herein may further include operations, features, means, or instructions for disabling the at least one mobility operation for a second network entity that the UE may be leaving, based on determining that the UE may be approaching the first network entity.

Some examples of the method, apparatuses, and non-transitory computer-readable medium described herein may further include operations, features, means, or instructions for deprioritizing measurements associated with a second network entity that the UE may be leaving, based on determining that the UE may be approaching the first network entity, where the at least one mobility operation includes the measurement reporting procedure.

Some examples of the method, apparatuses, and non-transitory computer-readable medium described herein may further include operations, features, means, or instructions for initiating a timer corresponding to a first measurement report associated with a first network entity of the set of multiple network entities, where the first network entity includes a serving cell for the UE and transmitting the first measurement report prior to expiration of the timer based on switching to the high mobility operating mode.

Some examples of the method, apparatuses, and non-transitory computer-readable medium described herein may further include operations, features, means, or instructions for initiating a timer corresponding to a first measurement report associated with a first network entity of the set of multiple network entities, where the first network entity includes a serving cell for the UE and transmitting, prior to expiration of the first measurement report and based on switching to the high mobility operating mode, a second measurement report associated with a second network entity of the set of multiple network entities, where the second network entity includes a neighbor cell for the UE.

Some examples of the method, apparatuses, and non-transitory computer-readable medium described herein may further include operations, features, means, or instructions for identifying a radio link failure between the UE and a first network entity of the set of multiple network entities and scanning a subset of available frequency resources based on switching to the high mobility operating mode, the subset of available frequency resources based on a cell map associated with the set of multiple network entities, where the at least one mobility operation includes the connection procedure, and where the connection procedure may be based on the scanning.

### BRIEF DESCRIPTION OF THE DRAWINGS

FIG. 1 illustrates an example of a wireless communications system that supports techniques for detecting high mobility and enhancing modem performance in accordance with one or more aspects of the present disclosure.

FIG. 2 illustrates an example of a wireless communications system that supports techniques for detecting high mobility and enhancing modem performance in accordance with one or more aspects of the present disclosure.

FIG. 3 illustrates an example of a flow diagram that supports techniques for detecting high mobility and enhancing modem performance in accordance with one or more aspects of the present disclosure.

FIG. 4 illustrates an example of a cell information database that supports techniques for detecting high mobility and enhancing modem performance in accordance with one or more aspects of the present disclosure.

FIG. 5 illustrates an example of a timeline that supports techniques for detecting high mobility and enhancing modem performance in accordance with one or more aspects of the present disclosure.

FIG. 6 illustrates an example of route information scheme that supports techniques for detecting high mobility and enhancing modem performance in accordance with one or more aspects of the present disclosure.

FIG. 7 illustrates an example of a process flow that supports techniques for detecting high mobility and enhancing modem performance in accordance with one or more aspects of the present disclosure. Process flow

FIGS. 8 and 9 show block diagrams of devices that support techniques for detecting high mobility and enhancing modem performance in accordance with one or more aspects of the present disclosure.

FIG. 10 shows a block diagram of a communications manager that supports techniques for detecting high mobility and enhancing modem performance in accordance with one or more aspects of the present disclosure.

FIG. 11 shows a diagram of a system including a device that supports techniques for detecting high mobility and enhancing modem performance in accordance with one or more aspects of the present disclosure.

FIGS. 12 and 13 show flowcharts illustrating methods that support techniques for detecting high mobility and enhancing modem performance in accordance with one or more aspects of the present disclosure.

### DETAILED DESCRIPTION

Some wireless communications systems may support wireless communication by a user equipment (UE) and one or more network entities in a high mobility scenario (e.g., a subway, a high-speed train (HST), freeway travel, etc.). However, UE performance may suffer in some high mobility scenarios. For instance, coverage along a high mobility route (e.g., HST track, subway track, or freeway) may be limited or poor, network neighbor cell configurations may be incomplete or unreasonable, or a UE may experience frequency radio link failure (RLF) or out of service (OOS) issues. Additionally, or alternatively, a reference signal receive power (RSRP) may drop sharply when a UE moves from a first location (e.g., a subway station that supports 5G services) to a second location (e.g., a subway tunnel that supports 4G services). If an RSRP drops too quickly in a short amount of time, the UE may fail to send a measurement report to the network, which may result in a handover failure. In some examples, the network may instruct the UE to perform a handover procedure to a target cell that the UE is leaving (e.g., is traveling away from along the route), which may result in RLF or OOS issues. In some examples, in the UE does experience RLF or OOS, the UE may perform a full band scan for a radio access technology that the UE is leaving, which may take an extended time period despite only a small number of channels being available along the route (e.g., resulting in an unnecessary delay or extended lack of service). Thus, despite network entities that provide wireless communications along the route, a UE may experience significant performance degradation, failed communications, increased system latency, failed handover procedures, and decreased user experience.

A UE may perform one or more mobility procedures according to a high mobility operating mode associated with travel along the route. Communicating according to a high mobility operating mode may result in improved performance, more reliable communications, decreased latency, less RLF or OOS issues, and improved user experience while traveling along the route (e.g., a subway track, an HST track, a commonly traveled route, or the like). However, to enter a high mobility operating mode, a UE may first detect one or more triggering conditions indicating that the UE is moving along the route (e.g., has entered the subway system, has boarded a train carriage or subway carriage, is moving along a consistently used route in a car or along a freeway, or the like).

The UE may detect one or more triggering conditions indicating that the UE is traveling along the route, and should enter the high mobility operating mode to improve mobility procedure performance or processor performance. For example, the UE may determine that it has entered or exited a subway or train station (e.g., by scanning an application granting access). The UE may sense a pressure differential resulting from train or subway doors opening or closing. In some cases, the UE may sense vibration, inertial, or motion (e.g., a vibration pattern) indicating that the UE is on the subway or HST. In some case, the UE may determine that it is located in a car, subway carriage, train carriage, or the like, based on camera or acoustic sensor data (e.g., an acoustic profile, a light environment, or both, associated with a form of communication). In some examples, the UE may detect global position system (GPS) or global navigation satellite system (GNSS) location data that matches the route. In some examples, GPS data may indicate whether the UE is underground or overground (e.g., based on the quality of GPS signaling). The UE may build a cell map, and determine that it is moving along the route if the UE camps on any of the cells of the cell map. The UE may input cell information to a cloud server, and the cloud server may provide the UE with a cell map (e.g., based on inputs from multiple end users). Having detected the one or more triggering conditions, the UE may enter the high mobility operating mode.

According to the high mobility operating mode, the UE may perform mobility procedures, handover procedures, cell selection or reselection, or connection procedures. For example, the UE may determine which cell it is approaching, and which cell it is leaving, along the route, which may allow the UE to avoid being assigned to handover to a cell that it is leaving, prioritize or deprioritize measurement reports for UEs that the UE is leaving or approaching, update the contents or timing of measurement reporting, or the like. For instance, the UE may receive synchronization signal blocks (SSBs) from one or more network entities, and may identify a cell that it is approaching based on whether the SSB is received before or after expected according to an SSB periodicity, or based on a Doppler of the SSB, or both. In some examples, the UE may determine which cell it is approaching based on the cell map. In the case of cell reselection, the UE may disable reselection to cells that the UE is leaving. In the case of connected mode operations, the UE may disable measurement report for the cell that the UE is leaving. In some examples, the UE may transmit measurement reports for target cells that the UE is approaching prior to transmitting measurement reports for a serving cell. In some examples, the UE may transmit measurement reports prior to expiration of a measurement timer, or may transmit measurement reports according to a shortened timer when operating in the high mobility operating mode. In some examples, the UE may refrain from performing full band scans (e.g., in case of RLF or OOS) when operating in the high mobility operating mode.

Aspects of the disclosure are initially described in the context of wireless communications systems. Aspects of the disclosure are further illustrated by and described with reference to wireless communications systems, flow diagrams, timelines, route information schemes, and process flows. Aspects of the disclosure are further illustrated by and described with reference to apparatus diagrams, system diagrams, and flowcharts that relate to techniques for detecting high mobility and enhancing modem performance.

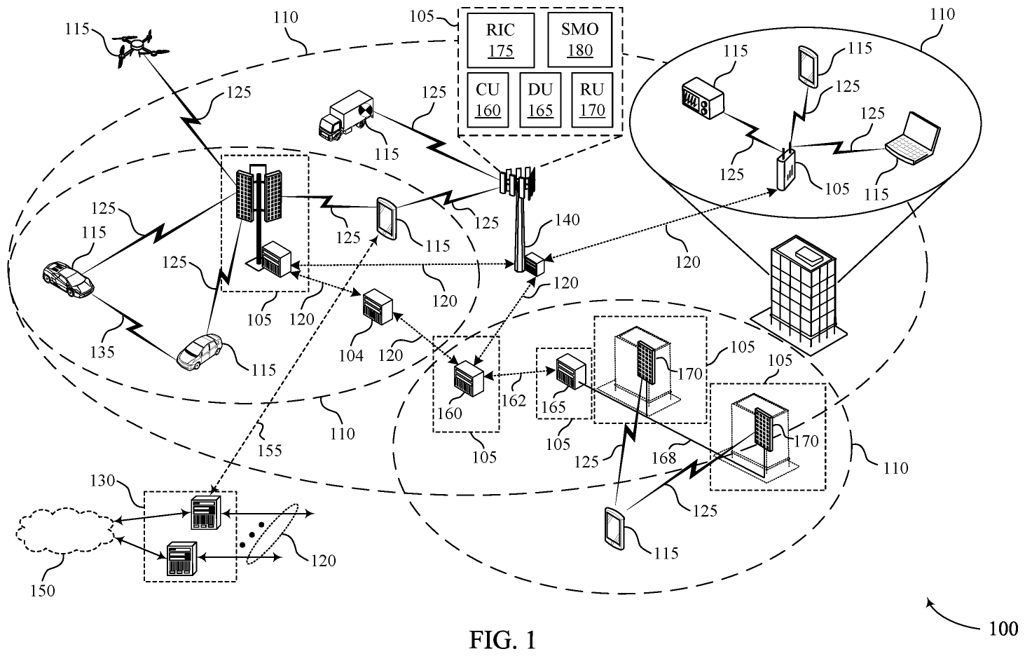

FIG. 1 illustrates an example of a wireless communications system 100 that supports techniques for detecting high mobility and enhancing modem performance in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocols). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for detecting high mobility and enhancing modem performance as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

A UE 115 may detect one or more triggering conditions indicating that the UE 115 is traveling along the route, and should enter the high mobility operating mode to improve mobility procedure performance or processor performance. Upon entering the high mobility operating mode, the UE 115 may perform mobility procedures, handover procedures, cell selection or reselection, or connection procedures. For example, the UE 115 may determine which cell it is approaching, and which cell it is leaving, along the route, which may allow the UE 115 to avoid being assigned to handover to a cell that it is leaving, prioritize or deprioritize measurement reports for UEs 115 that the UE 115 is leaving or approaching, update the contents or timing of measurement reporting, or the like.

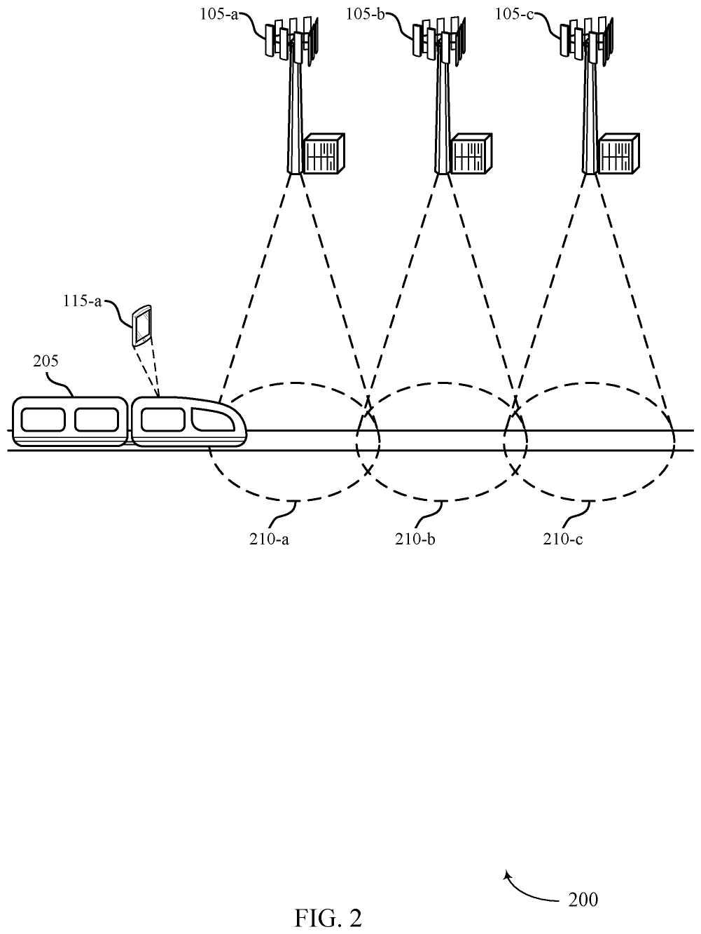

FIG. 2 illustrates an example of a wireless communications system 200 that supports techniques for detecting high mobility and enhancing modem performance in accordance with one or more aspects of the present disclosure. The wireless communications system 200 may implement or be implemented aspects of the wireless communications system 100. For example, the wireless communications system 200 may include a UE 115-a and network entities 105 (e.g., the network entity 105-a, the network entity 105-b, and the network entity 105-c), which may be examples of corresponding devices described herein, with reference to FIG. 1. In some examples, the UE 115-a may be located (e.g., traveling) in a vehicle 205 capable of high mobility (e.g., capable of traveling at high speed along a fixed or consistent route). In some examples, the vehicle 205 may be a subway train traveling along a track, a high-speed train (HST) traveling along a track, an automobile traveling along a highway, freeway, or commonly used route (e.g., a commute from home to work or vice versa), etc.

The UE 115-a may experience poor connectivity or coverage when traveling along a route in vehicle 205 (e.g., traveling at high speed along a track, underground, etc.). For example, the UE 115-a may experience radio link failure (RLF) and out-of-sync (OOS) conditions while traveling along the route (e.g., track or highway) and may fail to communicate a measurement report to a network entity 105. In some examples, network entities 105 along a subway track may provide different services, may support different radio access technologies (RATs), or may support different frequencies. For example, a subway station may be covered by a first wireless communications system (e.g., an NR system provided by one or more network entities 105-a for a subway station located in coverage area 210-a), and subway tunnels may be covered by a second wireless communication system (e.g., an LTE system provided by one or more network entities 105-b and one or more network entities 105-c for subway tunnels located in coverage area 210-b and coverage are 210-c). Furthermore, a vehicle 205 may enter or travel through one or more tunnels (e.g., along a highway or a subway track). For instance, if the network entity 105-a provides network coverage for a subway station, and the network entity 105-b provides network coverage for subway tunnels, then when the UE 115-a leaves the station and enters the tunnel (e.g., leaves coverage area 210-a and enters coverage area 210-b), the UE 115-a may experience a drop in reference signal received power (RSRP). In such examples, the UE 115-a may fail to send a measurement report, which may result in a handover failure (e.g., between the network entity 105-a and the network entity 105-b). Also, the UE 115-a may be quickly entering and exiting coverage areas 210 that may be associated with one or more network entities 105 (e.g., the UE 115-a may change cells quickly while moving along the route), which may result in frequent handover procedures as the UE 115-a attempts to establish or re-establish connections with network entities 105 along the route.

In some cases, due to the poor connectivity conditions resulting from the high mobility of travel along the route, the UE 115-a may experience a handover failure when moving from a coverage are 210-a associated with a network entity 105-a to a coverage area 210-b associated with a network entity 105-b. For example, network entity 105-a may instruct the UE 115-a to perform a handover procedure within the coverage area 210-a, which the UE 115-a is leaving. This may cause radio link failure or out-of-sync conditions, and the UE 115-a may attempt to perform a reconnection procedure (e.g., an acquisition database (ACQ-DB) search or a full band scan) for the coverage area 210-a. In high mobility conditions, however, there may be very limited connection frequencies available, and the reconnection procedures may not succeed. Further, the reconnection procedures may take long periods of time to complete, and cause delays in communications. Therefore, while experiencing high mobility conditions (e.g., traveling along the route), it may be beneficial for the UE 115-a to perform in a high mobility operating mode to enhance modem performance and connectivity in high mobility conditions. If the UE detects that it is experiencing high mobility conditions, the UE may switch from a default or previous operating mode to a high mobility operating mode.

The UE 115-a may detect that it is traveling in high mobility conditions (e.g., is traveling in a subway car or along a subway track, has entered a subway system, has boarded a HST, is traveling along a HST track, has entered a freeway, is traveling along a previously mapped route, or the like) due to one or more triggering conditions. For example, the UE 115-a may access a gateway through an application of the UE 115-a, indicating that the UE 115-a has entered the Subway and is to enter the high mobility operating mode. The UE 115-a may connect to a wireless local area network that may be associated with high mobility conditions (e.g., provided by the Subway or HST network). The UE 115-a may detect that it is traveling in high mobility conditions or is within a vehicle (e.g., a train carriage of a subway) through a sensor or application processor of (e.g., that is a part of, or otherwise coupled with) the UE 115-a. The UE 115-a may detect a drop in connectivity (e.g., a change in RSRP). The UE 115-a may detect that it is located on or traveling along a route that has been associated high mobility conditions. The UE 115-a may enable or disable the high mobility operating mode based on the detection of one or more of these triggering conditions.

In some cases, the vehicle 205 may often travel along a same route, which may follow a same sequence of coverage areas 210. The UE 115-a may store a mapping associated with coverage areas 210 (e.g., cells) that it connects to. For example, the UE 115-a may map information relating to a coverage area 210-b to information about a previous coverage area 210-a that the UE 115-a connected to, as well as information about a following coverage area 210-c that it connected to. In some cases, a mapping of common routes (e.g., subway routes) and network entities 105 that are available along these routes may be configured to the UE 115-a. The UE 115-a may use these mappings as triggering conditions for enabling or disabling the high mobility operating mode.

When the UE 115-a is operating in the high mobility operating mode, it may perform one or more procedures or operations for enhancing performance. For example, the UE 115-a may detect that it is approaching a neighbor network entity 105 associated with a coverage area 210 or leaving a network entity 105 associated with a neighbor coverage area 210 based on a doppler shift measurement, a timing change relative to a periodicity between two synchronization signal blocks (SSBs), the recorded mapping associated with coverage areas 210, or any combination thereof. The UE 115-a may be able to disable or deprioritize reselection procedures and measurement reports to a coverage area 210 that the UE 115-a determines that it is leaving. Additionally, or alternatively, the UE 115-a may prioritize measurement reports for a coverage area 210 that the UE 115-a determines that it is approaching. The UE 115-a may further include information about the approaching coverage area (e.g., doppler shift, timing change, etc.) in the measurement report to a network entity 105, so that the network entity 105 may have more information to decide the handover target. The UE 115-a may also adjust operating parameters for applications available to the UE 115-a. By operating in this high mobility operating mode, the UE 115-a may benefit from improved reliability in handover procedures and less frequent handover procedures and out-of-sync conditions due to avoiding reselection to a coverage area 210 that the UE 115-a is leaving.

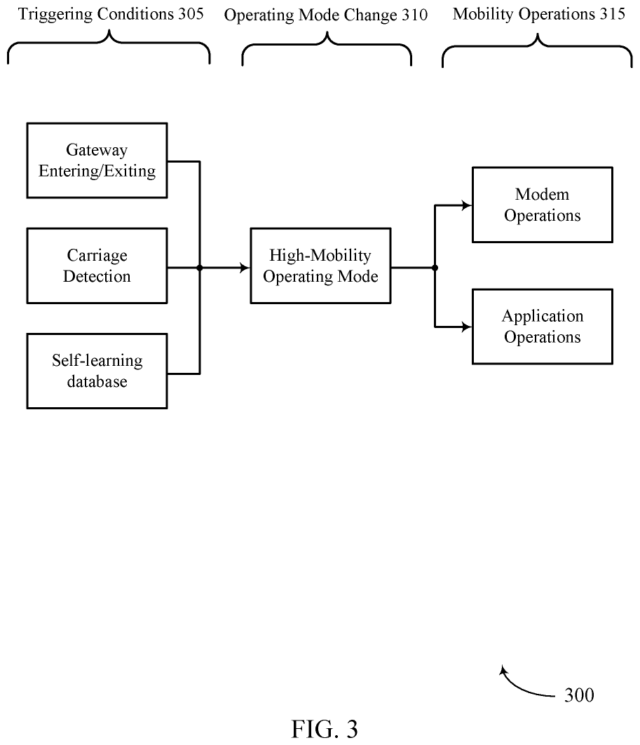

FIG. 3 illustrates an example of a flow diagram 300 that supports techniques for detecting high mobility and enhancing modem performance in accordance with one or more aspects of the present disclosure. Flow diagram 300 may implement or be implemented by aspects of wireless communications system 100 and wireless communications system 200. For example, a UE may communicate with one or more network entities while traveling along a route, and such devices may be examples of corresponding devices described with reference to FIGS. 1 and 2.

In some examples, a UE traveling along a route (e.g., a subway track, a HST track, a freeway, a highway, or the like) may experience reduced performance, increased RLF or OOS situations, increased latency, failed HO procedures, or the like. However, the UE may be capable of entering a high mobility operating mode, in which the UE may be able to mitigate or avoid some of the negative impacts of traveling along the route. The UE may determine that it is on or entering the route, and may enable the high mobility operating mode. Upon enabling the high mobility operating mode, the UE may perform one or more mobility operations.

The UE may detect triggering conditions 305. Detection of one or more triggering conditions 305 may indicate that the UE is on or entering the route. For example, if the UE detects a triggering condition 305, the UE may determine that it is traveling along a subway track or HST track, that it has entered a subway station, that subway or train car doors have opened or closed, that the UE is underground, that the UE has entered a highway, freeway, or frequently traveled route, or any combination thereof. In some examples, a combination of triggering conditions 305 may confirm a hypothesis that the UE is located on the route. In some examples, the UE may combine inputs from multiple sources or sensors (e.g., from application processor inputs, modem measurements, etc.) to improve reliability. If some sensors are off or unavailable, then the UE may still rely on other sensors, modem signatures, or the like, to detect triggering conditions 305.

The UE may detect a triggering condition 305 by detecting that the UE is entering or exiting a gateway (e.g., gaining access to an entrance to the route via an application executed by the UE). For example, a user may use an application to scan and gain entrance (e.g., gain access to a gateway) to enter a subway system (e.g., or other route, such as an HST system, a toll road, or the like). In such examples, foreground subway applications, or subway application main activity shown on the foreground of the UE (e.g., a near field communication (NFC) scan, a quick response (QR) code scan, or the like). In some examples, the UE may detect that it has entered the route by determining that the UE has established a connection with a peer-to-peer network (e.g., a Bluetooth network) provided by or supported by the Subway or HST system, or a WLAN system (e.g., an available Subway Wi-Fi signal) provided by or supported by the Subway or HST system. The UE may determine that the network is associated with the route based on information provided by the network, or based on previous associations with the network (e.g., which may be stored by the UE in a cell map, as described herein).

The UE may detect a triggering condition 305 by performing carriage detection. For example, the UE may detect that is located on a Subway carriage or HST carriage, or may detect train mobility. In some examples, the UE may use an air pressure sensor to detect that a door is open or is closed, or to detect that the UE is above ground (e.g., not in a subway carriage) or below ground (e.g., is in a subway carriage, or a subway station). For example, the UE may detect a change in air pressure when the doors of a Subway carriage open, or when the doors of a Subway carriage close. In some examples, the UE may measure amount of time between a drop in pressure (e.g., associated with a door of the subway carriage opening) and an increase in pressure (e.g., associated with the door of the subway carriage closing). Such a time period may be, for example, about twenty seconds. The measured time may be used to identify that the UE is located in a subway carriage (e.g., may further be used to differentiate between Subway and HST trains).

The UE may detect triggering conditions 305 based on detecting one or more sensor inputs. For example, the UE may use motion sensors to detect vibrations, inertia, or the like. For instance, the UE may detect a pattern of vibration that is associated with (e.g., unique to) travel in a subway carriage, may measure inertia associated with increase and decrease in velocity associated with Subway stops along a Subway line, or the like. In some examples, the UE may detect triggering conditions 305 using a camera, or acoustic sensors (e.g., microphones). For example, the UE may detect a profile of acoustic or lighting environments that are associated with (e.g., unique to) a Subway carriage, or Subway station. In some examples, the UE may use magnetic or ACCL sensors to detect a trains mobility along a track.

The UE may detect triggering conditions 305 based on a change in quality of service or signal strength associated with being in a subway carriage, being underground, transitioning from a subway station to a subway tunnel, or the like. For example, the UE may determine that a modem RSRP has dropped sharply (e.g., when moving form a subway station to a subway tunnel, when entering a tunnel, etc.). In such examples, the subway station may be served by a first system (e.g., an NR system) while the subway tunnel may be served by a second system (e.g., an LTE system). In such examples, the UE may experience a sharp drop in RSRP. (e.g., a measurable decrease in RSRP within a threshold period of time) indicating that the UE is traveling along the route (e.g., the UE is traveling along a Subway track).

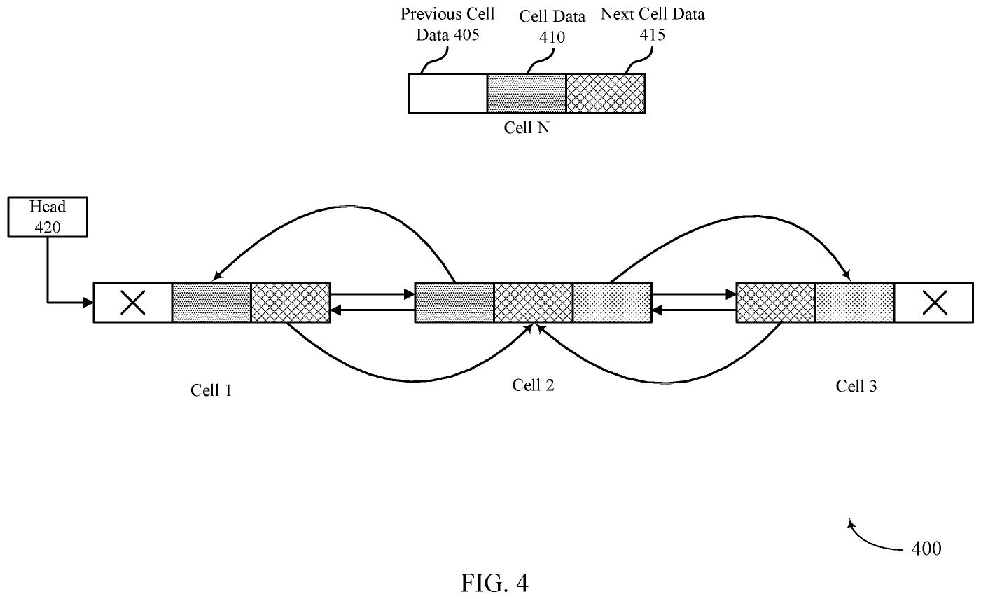

The UE may generate a self-learning local database (e.g., a cell map) to recover subway cell identifiers, supported frequencies, or the like, for certain routes. In such examples, the UE may detect triggering conditions 305 if the UE camps on or detects cells from the cell map, as described in greater detail with reference to FIG. 4. For example, a user may use a same route regularly in traveling from home to work, from home to school, or back home from any common destination (e.g., a same subway route, train route, or highway/road/freeway route, or a combination thereof). The UE may build a cell map of certain routes (e.g., commonly traveled Subway routes, HST routes, driven routes, etc.). The cell map may be stored in an application processor memory, which may save modem memory. The UE may communicate with one or more respective network entities during a time period, confirm an accuracy level of the cell map based on traveling along the route and communicating with network entities along the route, and may detect triggering conditions 305 when the UE camps on a network entity of multiple network entities along the route.

The UE may detect triggering conditions 305 based on a cloud server database. For example, end users may upload cell identifiers associated with a route (e.g., subway cell identifiers) to a cloud server. In some examples, testers may collect and upload cell identifiers associated with the route (e.g., subway cell identifiers) to the cloud server manually. The cloud server may then ush the cell map (e.g., subway fingerprint data) to the UE according to a real time location of the UE. For example, the UE may enter a subway station, detect that it is located in a subway carriage, or may detect any other triggering condition 305. Based on the location of the UE (e.g., or a query from the UE based on detecting the triggering conditions 305), the cloud server may provide the cell map to the UE. The UE may then enter the high mobility operating mode (e.g., subway mode), and may use the cell map to successfully camp on cells associated with the route (e.g., cells located along the Subway tracks). The UE may establish connections with respective network entities along the route, submit an indication of the respective network entities to the cloud server (e.g., along with multiple other users), and receive an indication of the cell map from the cloud server. The UE may detect a triggering condition 305 when it camps on a network entity of the received cell map.

Having detected one or more triggering conditions 305, the UE may perform an operating mode change 310. The UE may, for example, enter a high mobility operating mode (e.g., which may be referred to as a Subway mode, an HST mode, a route mode, a highway/freeway mode, or the like). When operating in the high mobility operating mode, the UE may improve modem operations, application operations, or the like, to mitigate or avoid poor connection, poor service, increases in RLF or OOS conditions, or the like, that the UE might otherwise experience while traveling along the route.

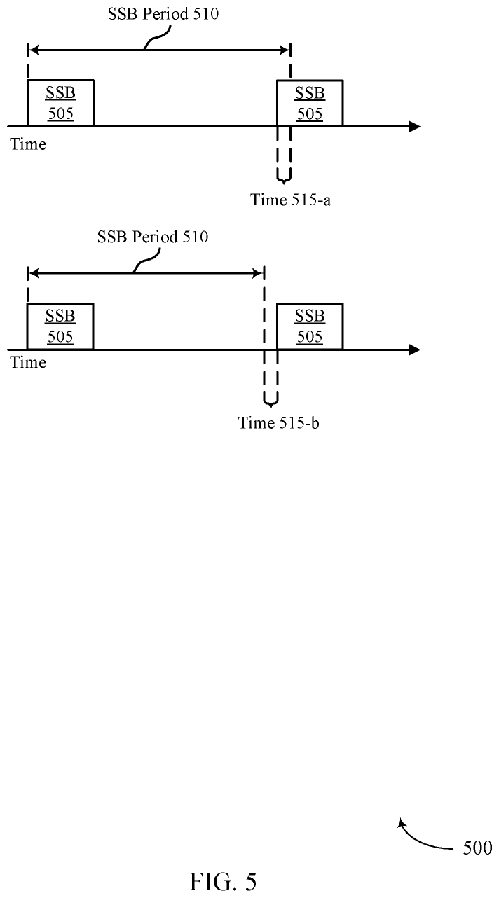

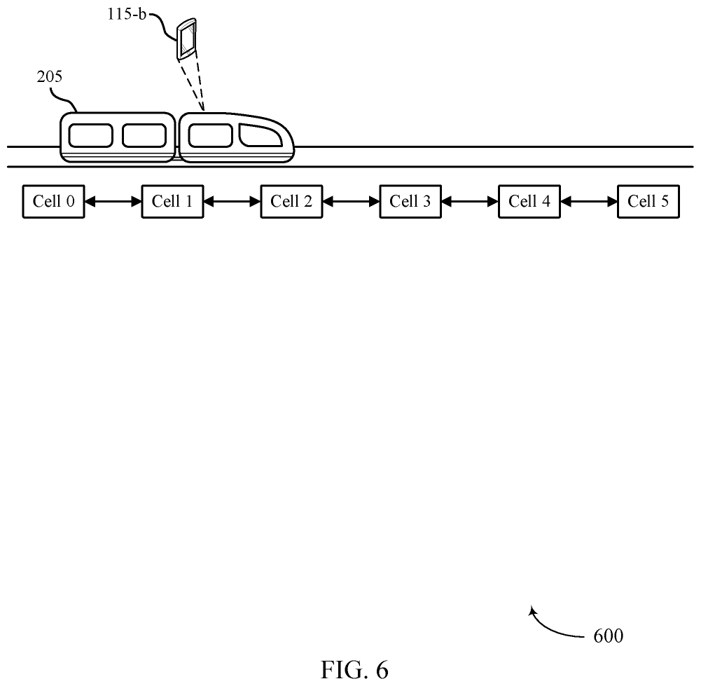

The UE may perform mobility operations 315, such as handover, connection, or reconnection procedures, among other examples, according to the high mobility operation mode. In some examples, the UE may detect a direction relative to one or more neighbor cells. For example, the UE may detect whether it is approaching or leaving a neighbor cell. If the UE selects a cell as a target cell for a handover procedure, but the UE is leaving the target cell, then the UE may fail to handover to the target cell, or may have to quickly or immediately perform a second handover procedure to another target cell, resulting in RLF, OOS conditions, increased latency, or the like. It may therefore be more efficient for the UE operating in the high mobility operating mode to determent whether the UE is approaching a cell or leaving a cell. The UE may then use the information to determine which cells are target cells in a mobility procedure (e.g., cell reselection in idle mode, measurement reporting in connected mode). The UE may determine whether it is approaching or leaving a neighbor cell based on one or more measurements (e.g., time measurements, Doppler shift measurements, or the like, which may result from a physical cell identifier (PCI) on an absolute radio frequency channel number (ARFCN)), as described in greater detail with reference to FIG. 5. In some examples, the UE may determine whether it is approaching or leaving a neighbor cell based on a cell map, as described in greater detail with reference to FIG. 4 and FIG. 6.

In some examples, the UE may consider the direction of a target or other neighbor cell for mobility procedures. For example, when performing a cell reselection procedure, the UE may disable cell reselection for one or more cells that the UE is leaving (e.g., unless all neighbor cells detected by the UE are cells that the UE is leaving, which may occur if the UE is at the end of Subway line, a last stop on an HST, a final destination, among other examples). In some examples, when operating in a connected mode, the UE may disable measurement reporting for one or more cells that the UE is leaving (e.g., unless all neighbor cells the UE detects are in the leaving direction). In some examples, the UE may deprioritize measure net results for the cell that the UE is leaving. For example, the UE may generate one or more measurements (e.g., idle mode measurements) for PCI on an ARFCN in the leaving direction, and may discount the measurements by an offset value O. In such examples, the UE may generate raw measurements such as srxlev and squal, among other examples. Yet, the UE may report the measurements including the Offset value O, such that the reported discounted measurement is srxlev−O, and sqal−O. Similarly, the UE may generate one or more measurements (e.g., connected mode measurements) for PCI on an ARFCN in the leaving direction discounted by an offset O. In such examples, the UE may generate raw measurements such as RSRP, and RSRQ, but may report the measurements including the offset value O, such that the reported discounted measurement is RSRP−O, and RSRQ−O. Such deprioritized reporting of cells that the UE is leaving may result in the UE selecting (e.g., receiving an indication from the network) a target cell that the UE is approaching, instead of a target cell that the UE is leaving.

In some examples, the UE may prioritize measurement results for a cell that the UE is approaching. The UE may add an offset value O to measurements associated with a cell that the UE is approaching. For example, the UE may generate one or more measurements (e.g., idle mode measurements) for PCI on an ARFCN in the approaching direction, and may augment the measurements by an offset value O. In such examples, the UE may generate raw measurements such as srxlev, and squal, among other examples. Yet, the UE may report the measurements including the Offset value O, such that the reported augmented measurement is srxlev+O, and sqal+O. Similarly, the UE may generate one or more measurements (e.g., connected mode measurements) for PCI on an ARFCN in the approaching direction augmented by an offset O. In such examples, the UE may generate raw measurements such as RSRP, and RSRQ, but may report the measurements including the offset value O, such that the reported augmented measurement is RSRP+O, and RSRQ+O. Such prioritized reporting of cells that the UE is approaching may result in the UE selecting (e.g., receiving an indication from the network) a target cell that the UE is approaching, instead of a target cell that the UE is leaving.

In some examples, the offset O (e.g., for prioritized reporting, deprioritized reporting, or both) may depend on an amount of Doppler shift measured by the UE (e.g., as described with reference to FIG. 5), a size of a timing change measured by the UE (e.g., as described with reference to FIG. 5), or both. Thus, the more speed the UE experiences (e.g., the faster it is traveling along the route in the Subway carriage, the HST carriage, or other vehicle), the higher the value of the offset O. Thus, the faster the UE is traveling, the more biased the reporting becomes, resulting in improved likelihood of selecting a target cell that the UE is approaching as the importance of such a selection becomes more relevant.

According to techniques described herein, the UE may improve the reliability of handover procedures, or cell reselection procedures, and may avoid frequent handover or cell reselection, by choosing a target cell in the UE approaching direction (e.g., in a subway environment or HST environment, among other examples) with more deterministic approaches to mobility routes.

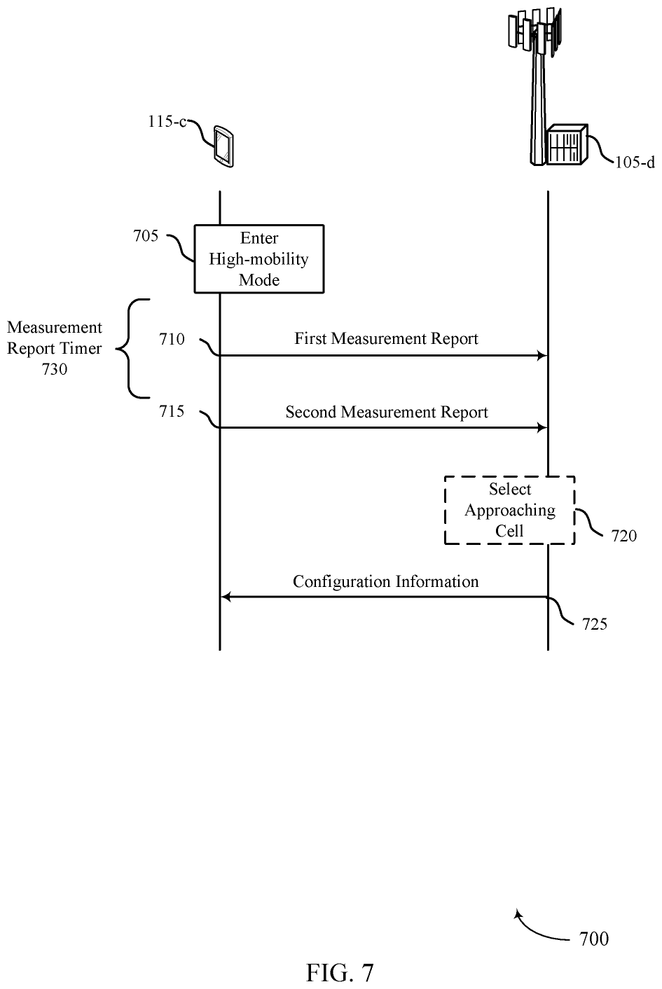

In some examples, the UE may include Doppler information, timing information, or both, in a measurement report, as described in greater detail with reference to FIG. 7. In some examples, the UE may adjust a priority of various types of reports based on entering the high mobility operating mode (e.g., may transmit a neighbor cell measurement report before transmitting a serving cell report) as described in greater detail with reference to FIG. 7. In some examples, the UE may transmit a quick measurement report (e.g., may skip a time-to-trigger (TTT) timer or may use a shortened TTT timer) if the UE detects one or more triggering conditions (e.g., detects a sharp RSRP drop when moving from a station to a tunnel), as described in greater detail with reference to FIG. 7.

The UE may perform a quick (e.g., an abbreviated search or targeted search) for a new cell when the UE is operating in the high mobility operation mode. For example, a UE may experience RLF or OOS while traveling along the route. However, only some frequency resources or some RATs, may be supported by cells along the route (e.g., a Subway system may be a closed space, and only one or two frequency may be supported in the underground space). Thus, a full band scan, or an ACQ DB search may expend computational resources and waste time unnecessarily. Instead, the UE may skip an ACQ DB search and a full band scan. The UE may quickly search neighbor cells, or frequency resources associated with neighbor cells (e.g., according to the cell map, or a defined set of targeted or available frequency resources, among other examples). For instance, the UE may scan a subset of available frequency resources based on switching to the high mobility operating mode. The subset of available frequency resources may be based on the cell map associated with the network entities. (e.g., the UE may identify neighbor cell information in a cell map, as described with reference to FIG. 4). In such examples, the UE may avoid experiencing OOS conditions for an extended period of time, may avoid remaining in 2G or 3G for extended periods of time, and may more quickly and accurately (e.g., while conserving power and computational resources) identify neighbor cells and connect with neighbor cells.

In some examples, when the UE falls back to 2G or 3G coverage due to poor NR coverage or poor LTE coverage, the UE may remain stuck in 2G or 3G service due to poor neighbor cell configuration. However, if the UE is able to find a good LTE cell or NR cell in the cell map, then the UE may quickly search and return to LTE cells or NR cells. This may avoid the UE being stuck in 2G or 3G service.

In some examples, the UE may indicate that it has switched to the high mobility operating mode to third party applications. In such examples, the UE may augment or improve its application operations. For instance, third party applications may use larger buffer size to store online videos, websites, streaming data, or the like, when network coverage is good. For instance, the third party application may use a larger buffer size to store video data when coverage is good (e.g., when the UE is connected to an NR network entity 105 at a Subway station) to support uninterrupted video streaming when the UE is located in a tunnel (e.g., and network coverage is poor). In some examples, third party applications may adapt video rates when the UE indicates that it has switched to the high mobility operating mode.

FIG. 4 illustrates an example of a route information scheme 400 that supports techniques for detecting high mobility and enhancing modem performance in accordance with one or more aspects of the present disclosure. Route information scheme 400 may implement or be implemented by aspects of wireless communications system 100 and wireless communications system 200. For example, a UE may communicate with one or more network entities, and may generate or receive information including or included in the route information scheme 400. Such devices may be examples of corresponding devices described with reference to FIGS. 1, 2, and 3.

In some examples, a UE may generate a cell map, which may include the route information scheme 400 using a self-learning local database. For example, the UE may generate a self-learning local database (e.g., the cell map) to recover subway cell identifiers, supported frequencies, or the like, for certain routes. In such examples, the UE may detect triggering conditions if the UE camps on or detects cells from the cell map.

A user may use a same route regularly in traveling from home to work, from home to school, or back home from any common destination (e.g., a same subway route, train route, or highway/road/freeway route, or a combination thereof). The UE may build a cell map of certain routes (e.g., commonly traveled Subway routes, HST routes, driven routes, etc.). For instance, the UE may travel along a route from a head 420 (e.g., an initial stop on a Subway or HST route, among other examples) to a final destination, and may pass through a number of coverage areas (e.g., associated with cell 1, cell 2, and cell 3). The UE may connect with, or otherwise identify information associated with each cell N as the UE travels along the route. For example, for each cell N, the UE may identify frequency resources supported by the cell, one or more RATs supported by the cell, a cell identifier associated with the cell, or any other information that may assist the UE in performing mobility procedures, cell selection or reselection procedures, scanning procedures, or other wireless communications in idle mode or connected mode.

The UE may store the cell map in an application processor memory, which may save modem memory. In some examples, the cell map (e.g., a subway cell map or HST cell map) may be stored as a double linked list. In such examples, a RAT, an ARFCN, a PCI, a CGI, or any other parameters, may be stored for each cell of the cell map. Thus, the UE may identify relevant information for each cell N along the route, which may be utilized for one or more mobility operations, as described herein. The UE may generate the cell map such that, for each cell N, the UE can identify previous cell data 405 (e.g., a RAT, an ARFCN, a PCI, a CGI, or any other parameters, for the previous cell), cell data 410 (e.g., a RAT, an ARFCN, a PCI, a CGI, or any other parameters supported by the cell N, among other examples), and next cell data 415 (e.g., a RAT, an ARFCN, a PCI, a CGI, or any other parameters supported by a next cell, among other examples). Thus, the UE may use an established cell map to identify neighbor cells more accurately and quickly, perform mobility procedures, improve reliability of connectivity, or other communications, or a combination thereof. For instance, the UE may connect to cell 1 (e.g., may detect triggering conditions, and may enter a high mobility operating mode, and load the cell map to the modem). The UE may access cell 1 of the cell map, and identify next cell data 415 associated with cell 2. The UE may use such information to successfully (e.g., quickly and efficiently) perform a handover to cell 2 or establish a connection with cell 2 in the event of RLF or OOS conditions at cell 1. The UE may determine (e.g., while connected to cell 2) previous cell data 405 associate with cell 1, next cell data 415 associated with cell 3, or both. The UE may use this information to successfully connect with (e.g., perform a handover procedure, or a cell reselection procedure) cell 3. In some examples (e.g., as described with reference to FIGS. 5-6), the UE may use the cell map to determine that the UE is approaching cell 3 (e.g., and leaving cell 1 or cell 2), which may assist measurement reporting or handover procedures, among other examples. The UE may similarly use the cell map when traveling the route in the opposite direction (e.g., traveling from cell 3, to cell 2, and from cell 2 to cell 1).

In some examples, a UE may continue to develop the cell map over time. For example, when the application processor (e.g., where the cell map is stored) may detect that the UE is on the route (e.g., based on any of the triggering conditions) the UE may enter the high mobility operating mode. While in the high mobility operating mode, the UE may record cells along the route (e.g., cells from which the UE detects signaling, such as SSBs, cells to which the UE successfully connects, or the like). In some examples, the UE may confirm a reliability of a developed cell map. For example, the UE may determine that if a user takes a same route (e.g., travels the same Subway route) a threshold number of times (e.g., more than a number N times), the cell map may be trusted. If the UE subsequently camps on a cell in the local cell map, the UE may determine that it is located on the route, and may enter the high mobility operating mode. In such examples, the UE may load the cell map associated with the identified route to the modem of the UE. The modem may then use the cells listed in the cell map to assist in idle or connected mobility, to address RLF or OOS searching, or the like.

FIG. 5 illustrates an example of a timeline 500 that supports techniques for detecting high mobility and enhancing modem performance in accordance with one or more aspects of the present disclosure. that supports detecting high mobility and enhancing modem performance. timeline 500 may implement or be implemented by aspects of the wireless communications system 100, or the wireless communication system 200. For example, a UE may communicate with one or more network devices while traveling along a route, and the UE and network devices may be examples of corresponding devices described with reference to FIGS. 1-4.

When operating in the high mobility operating mode, a UE 115 may determine a target cell (e.g., of the network entity) for a mobility procedure (e.g., reselection in an idle mode, measurement report in a connected mode, etc.). The UE 115 may determine that it is leaving a neighbor cell associated with a network entity and approaching another neighbor cell (e.g., associated with a different network entity). The UE may improve performance of various mobility operations, measurement reporting, or the like, based on determining which cell the UE is approaching, and which cell the UE is leaving. For instance, the UE may user the determination of whether the UE is approaching a neighbor cell or leaving a neighbor cell as an input to determine a target cell in a mobility procedure (e.g., reselection in an idle mode, measurement report in a connected mode, etc.).

In some examples, the UE may determine whether it is approaching a neighbor cell or leaving a neighbor cell based on a measurement result of a PCI on an ARFCN, such as a Doppler shift measurement. A Doppler shift measurement may be represented as a change in frequency over a carrier frequency (e.g., (Df/fc)). The UE may determine the Doppler shift (Df/fc) for one or more received signals from a network entity (e.g., one or more SSBs 505) using a frequency tracking loop (FTL). A Doppler shift that is greater than zero may indicate that the UE 115 is approaching the neighbor cell, while a Doppler shift amount less than zero may indicate that the UE 115 is leaving the neighbor cell.

In some examples, the UE may determine whether it is approaching a neighbor cell or leaving a neighbor cell based on a measurement of a timing change (e.g., a timing offset from an excepted receive time of a downlink signal). For example, the UE may receive SSBs 505 according to a periodicity. For example, the periodicity may be calculated as a constant (e.g., K) times a known value (e.g., SSB_periodicity, which may be configured by a network entity or otherwise determined by the UE). Thus, the UE may monitor for (e.g., expect to receive) SSBs 505 upon expiration of each SSB period 510. The UE may detect a timing change if it receives an SSB 505 prior to expiration of the SSB period 510 by a time 515, or if it receives an SSB 505 after expiration of the SSB period 510 by a time 515. The amount of timing change (Dt) may be determined relative to the measured time 515. The UE may determine a timing change (Dt) relative to the periodicity between two SSB samples (e.g., SSB period 510) using a time tracking loop (TTL). The UE may receive an SSB 505 time 515-a prior to expiration of SSB period 510. A timing change amount less than zero (e.g., receiving the SSB 505 prior to expiration of the SB period by time 515-a) may indicate that the UE 115 is approaching the neighbor cell. In some examples, the UE may receive an SSB 505 a time 515-b after expiration of an SSB period 510. A timing change amount greater than zero (e.g., receiving the SSB 505 after expiration of SSB period 510) may indicate that the UE 115 is leaving the neighbor cell. In some examples, the UE may determine whether it is approaching a neighbor cell or leaving a neighbor cell based on both a Doppler shift and a timing change. For example, the UE may determine that it is approaching a first neighbor cell if a measured Doppler shift Df/fc associated with the first neighbor cell is greater than zero (e.g., (Δf/fc>0)), or if the timing change Dt associated with the first neighbor cell is less than zero (e.g., Δt<0), or both. In some examples, the UE may determine that it is leaving a second neighbor cell if a measured Doppler shift Df/fc associated with the first neighbor cell is less than zero (e.g., (Δf/fc<0)), or if the timing change Dt associated with the first neighbor cell is greater than zero (e.g., Δt>0), or both.

If the UE 115 determines that it is approaching a network entity 105, it may decide to target a cell of an approaching neighbor network entity 105 (e.g., for a handover procedure or other mobility procedure). This may improve the reliability in handover procedures and avoid frequent handover or cell reselection that may occur if the UE 115 were to choose a target cell that the UE 115 is leaving for handover.

FIG. 6 illustrates an example of a route information schemes 600 that supports techniques for detecting high mobility and enhancing modem performance in accordance with one or more aspects of the present disclosure. Route information scheme 600 may implement or be implemented by aspects of wireless communications system 100 and wireless communications system 200. For example, a UE 115-b may communicate with one or more network entities while traveling along a route on a vehicle 205 (e.g., a subway carriage, an HST carriage, a car, or the like), and may generate or receive information including or included in the route information scheme 600. Such devices (e.g., the UE 115-b and one or more network entities associated with Cell 0, Cell 1, Cell 2, Cell 3, Cell 4, and Cell 5) may be examples of corresponding devices described with reference to FIGS. 1-5.

When operating in the high mobility operating mode, a UE 115-b may determine a target cell (e.g., associated with a network entity) for a mobility procedure (e.g., reselection in an idle mode, measurement report in a connected mode, etc.). The UE 115-b may determine that it is leaving a neighbor cell associated with a network entity and approaching another neighbor cell (e.g., associated with a different network entity). The UE 115-b may improve performance of various mobility operations, measurement reporting, or the like, based on determining which cell the UE 115-b is approaching, and which cell the UE 115-b is leaving. For instance, the UE 115-b may user the determination of whether the UE 115-b is approaching a neighbor cell or leaving a neighbor cell as an input to determine a target cell in a mobility procedure (e.g., reselection in an idle mode, measurement report in a connected mode, etc.).

In some examples, the UE 115-b may use a cell map to detect a mobility direction (e.g., determine whether it is approaching or leaving a particular neighbor cell). The UE 115-b may generate the cell map using a local cell map database, or may receive the cell map from a cloud server, as described with reference to FIG. 3. For example, while traveling along the route on vehicle 205, the UE 115-b may determine that it is moving from Cell 0 to Cell 1, from Cell 1 to Cell 2, or the like. The UE may determine, based on the direction and the cell map, that (e.g., while connected to Cell 5), a next cell along the route may be Cell 5. In such examples, the UE may determine that it is approaching Cell 4 (e.g., and leaving Cell 3), and may select Cell 4 as a preferred candidate target cell for a handover procedure.

In some examples, the UE may determine a moving direction based on past procedures, a based on the cell map (e.g., may confirm an accuracy of the cell map). For example, the UE may determine that, after more than a threshold number (e.g., N) of idle reselection or handover procedures, the UE may confirm a direction of motion along the route (e.g., and may therefore determine which cells the UE is approaching or leaving based on travel along the route).

FIG. 7 illustrates an example of a process flow 700 that supports techniques for detecting high mobility and enhancing modem performance in accordance with one or more aspects of the present disclosure. Process flow 700 may implement or be implemented by aspects of wireless communications system 100 or wireless communications system 200. For example, the process flow 700 may include a UE 115-b and a network entity 105-d, which may be examples of corresponding devices described with reference to FIGS. 1-6.

The UE 115-c may perform measurement reporting, or one or more mobility procedures, based on a direction of one or more detected cells (e.g., as described with reference to FIGS. 5-6). In some examples, the UE 115-a may include Doppler shift or timing change information in measurement reports (e.g., in connected mode), such that the network entity 105-d may use the information to determine a handover target. For example, the UE 115-c may enter a high mobility operating mode at 705 (e.g., based on detecting one or more triggering conditions). The UE 115-c may transmit a first measurement report at 710 to the network (e.g., via network entity 105-d). The first measurement report may include (e.g., in one or more dedicated fields) an indication of a Doppler shift, or a timing change, or both. For example, the first measurement report may include a raw Doppler shift measurements and timing change measurements, or may include an indication of whether the measured Doppler shift is greater than 0 (i.e., positive Doppler shift) or less than 0 (i.e., a negative Doppler shift), or whether a timing change is greater than 0 or less than 0 (e.g., such measurements and detections are described with reference to FIG. 5). For instance, the UE 115-c may perform cell measurements on a first cell, and may transmit the first measurement report at 710. The first measurement report may include a PCI1 for the first cell, an ARCN associated with the first cell, and an indication that the measured Doppler shift is less than 0, while the measured timing change is greater than 0. Such information may indicate, to the network entity 105-d, that the UE is leaving the first neighbor cell.

The UE 115-c may transmit, at 715, a second measurement report for a second cell. The second measurement report may include a PCI2 for the second cell, an ARFCN associated with the second cell, and an indication that the Doppler shift for the second cell is greater than 0, while the timing change measured for the second cell is less than zero. Such information may indicate, to the network entity 105-d, that the UE is approaching the second neighbor cell.

In such examples, the network may select a neighbor cell for handover if Doppler shift or timing change information shows that the cell is located in the direction that the UE 115-c is approaching (e.g., Doppler shift is greater than 0, or timing change is less than 0, or both). At 720, the network entity 105-d (e.g., or any other network entity) may select the approaching cell (e.g., the second neighbor cell based on the second measurement report) instead of the leaving cell, for a handover procedure. In some examples the network entity 105-d may avoid selecting a neighbor cell for handover if Doppler shift or timing change information shows that the cell is in the direction that the UE 115-c is leaving (e.g., if the Doppler shift is less than 0, the timing change is greater than 0, or both) unless all other good-signal neighbor cells are in the leaving direction, and the serving cell has a poor signal. In such examples, the network entity 105-d may avoid selecting the first neighbor cell (e.g., based on the first measurement report).

The network entity 105-d may transmit, to the UE 115-c at 725, configuration information. The configuration information may be, for example, a higher layer signal parameter (e.g., a radio resource control (RRC) parameter, such as RRCreconfiguration) indicating a new target cell (e.g., the second cell). For instance, the configuration information may include an indication of the second cell (e.g., a parameter such as reconfigWithSync, a PCI2 for the second cell, an ARFCN associated with the second cell, among other examples).

In some examples, the UE may perform measurement report improvement to assist network handover target selection. For example, in some wireless communications systems, a UE 115-c may be configured (e.g., by the network) with measurement events associated with neighbor cell measurements (e.g., B1/B2 measurement events) for handover or redirection (e.g., NR2L). However, the network may not send a handover or redirection command until a first measurement event associated with the current serving cell (e.g., A2 measurement event) is reported. Upon transmission of the measurement report associated with the serving cell, the UE may be permitted to transmit the measurement report associated with potential target cells. If the network receives the A2 measurement report and the B1/B2 measurement report, the network may transmit or receive a measurement based on the NR2L redirection or handover command. However, in some examples, as described herein with reference to FIGS. 2 and 3, the UE 115-c may experience rapid drops in RSRP, or may otherwise be unable to transmit a measurement report after some time has passed (e.g., while entering a tunnel, or the like). In such examples, the network entity 105-d may blindly select a target cell (e.g., having not received a measurement report associated with one or more neighbor cells). In such examples, the network entity 105-d may send a NR2L blind redirection, which may cause a handover or redirection for the UE 115-c to a bad target cell (e.g., a target sell with poor signal quality, a target cell that the UE is leaving, or the like).

Instead, the UE 115-c may support transmission of a measurement report associated with a target cell prior to transmission of a report associated with a serving cell. In some examples, when an A2 measurement report threshold is satisfied, if an NR2L B1/B2 measurement event is under evaluation but a measurement report timer 730 (e.g., a TTT timer) associated with the B1/B2 measurement event has not yet expired, the UE 115-c may transmit the pending B1/B2 measurement report prior to transmitting the A2 measurement report. This may assist the network to handover the UE 115-c to the right cell. For instance, the UE 115-c may generate the second measurement report associated with a serving cell, for transmission upon expiration of the measurement report time 730. However, the UE 115-c may transmit a first measurement report associated with a neighbor cell to the network entity 105-d at 710 prior to expiration of the measurement report timer 730, and prior to transmitting the second measurement report at 715. Then, at 720, the network entity 105-d may be able to accurately select a neighbor cell (e.g., that the UE 115-c is approaching) for handover, and may indicate the selected target cell at 725. Such procedures may be performed for Subway travel, HST travel, or highway travel. Such procedures may avoid NR2L redirection failure.

In some examples, the UE 115-c may support fast handover procedures when operating according to the high mobility operating mode (e.g., when transitioning from a station to a tunnel). For example, the UE 115-c may send quick measurement reports. The UE 115-c may transmit a first measurement report (e.g., for a neighbor cell, a serving cell, or any other cell) upon expiration of a measurement report timer 730 (e.g., a TTT timer). However, if the UE 115-c detects one or more triggering conditions (e.g., detects an RSRP drop when moving from a station to a tunnel), the UE 115-c may transmit the first measurement report prior to expiration of the measurement report timer 730. For instance, the UE 115-c may be able to transmit the first measurement report by skipping the measurement report timer 730, or may transmit the first measurement report according to a shortened or abbreviated timer, upon detecting the one or more triggering conditions. This may result in avoiding a handover failure that might otherwise occur if the UE 115-c waits to transmit the first measurement report while RSRP is dropping rapidly.

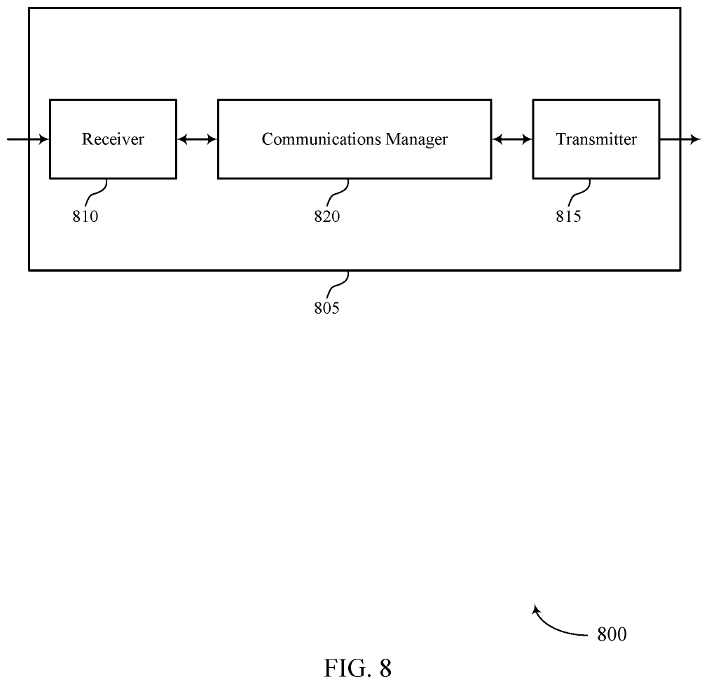

FIG. 8 shows a block diagram 800 of a device 805 that supports techniques for detecting high mobility and enhancing modem performance in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for detecting high mobility and enhancing modem performance). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for detecting high mobility and enhancing modem performance). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for detecting high mobility and enhancing modem performance as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE in accordance with examples as disclosed herein. For example, the communications manager 820 may be configured as or otherwise support a means for detecting one or more triggering conditions associated with travel along a route corresponding to a set of multiple network entities. The communications manager 820 may be configured as or otherwise support a means for switching from a default operating mode to a high mobility operating mode based on detecting the one or more triggering conditions. The communications manager 820 may be configured as or otherwise support a means for performing at least one mobility operation including a handover procedure, a neighbor cell reselection procedure, a measurement reporting procedure, or a connection procedure, according to the high mobility operating mode.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for operating mode switching that may result in decreased system latency, more reliable connections, less time spent in RLF or OOS conditions, more efficient use of computational resources, and improved user experience.

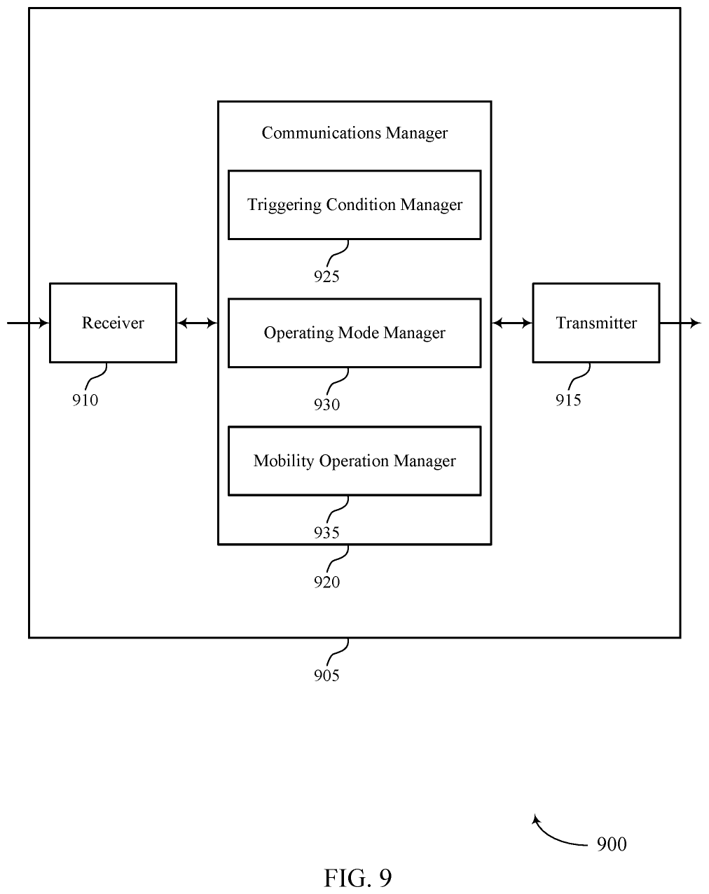

FIG. 9 shows a block diagram 900 of a device 905 that supports techniques for detecting high mobility and enhancing modem performance in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for detecting high mobility and enhancing modem performance). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for detecting high mobility and enhancing modem performance). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for detecting high mobility and enhancing modem performance as described herein. For example, the communications manager 920 may include a triggering condition manager 925, an operating mode manager 930, a mobility operation manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a UE in accordance with examples as disclosed herein. The triggering condition manager 925 may be configured as or otherwise support a means for detecting one or more triggering conditions associated with travel along a route corresponding to a set of multiple network entities. The operating mode manager 930 may be configured as or otherwise support a means for switching from a default operating mode to a high mobility operating mode based on detecting the one or more triggering conditions. The mobility operation manager 935 may be configured as or otherwise support a means for performing at least one mobility operation including a handover procedure, a neighbor cell reselection procedure, a measurement reporting procedure, or a connection procedure, according to the high mobility operating mode.

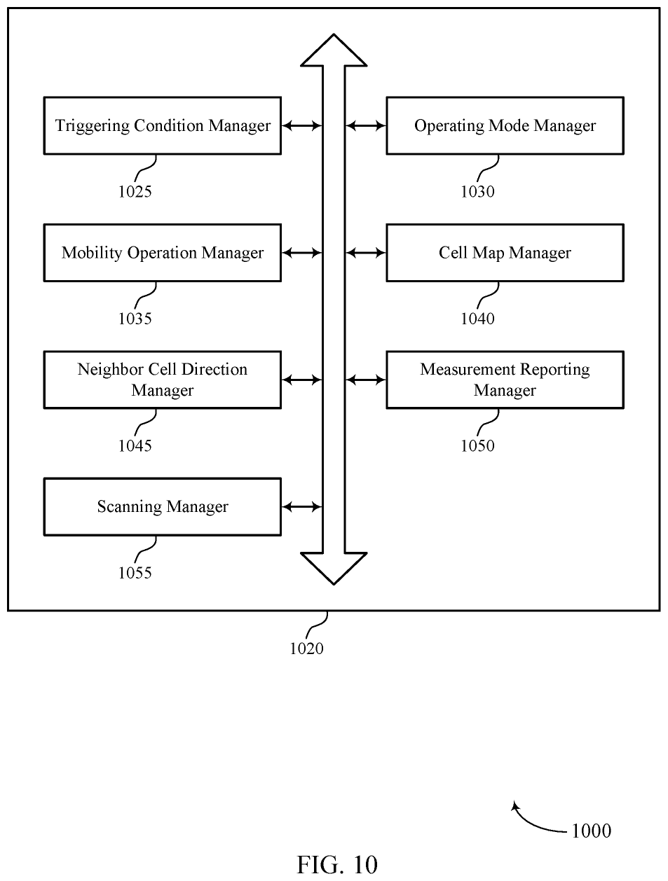

FIG. 10 shows a block diagram 1000 of a communications manager 1020 that supports techniques for detecting high mobility and enhancing modem performance in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for detecting high mobility and enhancing modem performance as described herein. For example, the communications manager 1020 may include a triggering condition manager 1025, an operating mode manager 1030, a mobility operation manager 1035, a cell map manager 1040, a neighbor cell direction manager 1045, a measurement reporting manager 1050, a scanning manager 1055, or any combination thereof. Each of these components may communicate, directly or indirectly, with one another (e.g., via one or more buses).

The communications manager 1020 may support wireless communications at a UE in accordance with examples as disclosed herein. The triggering condition manager 1025 may be configured as or otherwise support a means for detecting one or more triggering conditions associated with travel along a route corresponding to a set of multiple network entities. The operating mode manager 1030 may be configured as or otherwise support a means for switching from a default operating mode to a high mobility operating mode based on detecting the one or more triggering conditions. The mobility operation manager 1035 may be configured as or otherwise support a means for performing at least one mobility operation including a handover procedure, a neighbor cell reselection procedure, a measurement reporting procedure, or a connection procedure, according to the high mobility operating mode.

In some examples, to support detecting the one or more triggering conditions, the triggering condition manager 1025 may be configured as or otherwise support a means for accessing an entrance to the route via an application executed by the UE, where the route includes a subway route, a high-speed train route, a freeway route, or a combination thereof. In some examples, to support detecting the one or triggering conditions, the triggering condition manager 1025 may be configured as or otherwise support a means for connecting to a wireless local area network associated with the route. In some examples, to support detecting the one or more triggering conditions, the triggering condition manager 1025 may be configured as or otherwise support a means for detecting a sensor input indicating that the UE is located on the route, within a vehicle associated with the route, or both.

In some examples, to support sensor input, the triggering condition manager 1025 may be configured as or otherwise support a means for a pressure measurement associated with train car door opening or closing, a pressure measurement associated with entering an underground train station, a motion sensor measurement indicating a vibration pattern, a camera input indicating a lighting environment associated with a train car or train station, a microphone input indicating an acoustic pattern associated with the train car or train station, a magnetic sensor measurement indicating high mobility on a train or subway, a GPS input indication a location along the route, a GPS signal strength that satisfies a threshold signal strength level, or any combination thereof. In some examples, to support detecting the one or more triggering conditions, the triggering condition manager 1025 may be configured as or otherwise support a means for detecting a change in reference signal receive power (RSRP) that satisfies a threshold.

In some examples, the cell map manager 1040 may be configured as or otherwise support a means for communicating with one or more respective network entities of the set of multiple network entities one or more times during a time period. In some examples, the cell map manager 1040 may be configured as or otherwise support a means for confirming an accuracy level of a cell map including information associated with the set of multiple network entities based on traveling along the route and communicating with the set of multiple network entities at least a threshold number of times. In some examples, the cell map manager 1040 may be configured as or otherwise support a means for establishing a connection with a first network entity of the set of multiple network entities, where detecting the one or more triggering conditions includes determining that the first network entity is associated with the cell map.

In some examples, the cell map manager 1040 may be configured as or otherwise support a means for establishing one or more connections with respective network entities of the set of multiple network entities one or more times during a time period. In some examples, the cell map manager 1040 may be configured as or otherwise support a means for submitting an indication of the respective network entities of the set of multiple network entities to a cloud server. In some examples, the cell map manager 1040 may be configured as or otherwise support a means for receiving, from the cloud server based on submitting the indication of the respective network entities and a current location of the UE within the route, an indication of a cell map including information associated with the set of multiple network entities. In some examples, the cell map manager 1040 may be configured as or otherwise support a means for establishing a connection with a first network entity of the set of multiple network entities, where detecting the one or more triggering conditions includes determining that the first network entity is associated with the cell map.

In some examples, the neighbor cell direction manager 1045 may be configured as or otherwise support a means for determining that the UE is approaching a first network entity of the set of multiple network entities, where performing the at least one mobility operation is based on the determining. In some examples, the neighbor cell direction manager 1045 may be configured as or otherwise support a means for receiving a synchronization signal block from the first network entity prior to expiration of a synchronization signal block periodicity by a timing offset, where the determining is based on the receiving. In some examples, the neighbor cell direction manager 1045 may be configured as or otherwise support a means for detecting a positive Doppler shift based on a frequency tracking loop, where the determining is based on detecting the positive Doppler shift.

In some examples, the measurement reporting manager 1050 may be configured as or otherwise support a means for transmitting a measurement reporting including an indication of a detected timing offset at which the UE received a synchronization signal block from the first network entity, a detected Doppler shift, or both. In some examples, the measurement reporting manager 1050 may be configured as or otherwise support a means for receiving, from a second network entity, a reconfiguration message including an indication with the first network entity, where determining that the UE is approaching the first network entity is based on the reconfiguration message. In some examples, the measurement reporting manager 1050 may be configured as or otherwise support a means for performing the handover procedure with the first network entity based on the reconfiguration message, where the at least one mobility operation includes the handover procedure.

In some examples, the cell map manager 1040 may be configured as or otherwise support a means for building a cell map including information associated with the set of multiple network entities based on communicating with respective network entities of the set of multiple network entities. In some examples, the neighbor cell direction manager 1045 may be configured as or otherwise support a means for determining a moving direction along the route based on the cell map, where determining that the UE is approaching the first network entity is based on the moving direction and the cell map.

In some examples, the mobility operation manager 1035 may be configured as or otherwise support a means for disabling the at least one mobility operation for a second network entity that the UE is leaving, based on determining that the UE is approaching the first network entity.

In some examples, the measurement reporting manager 1050 may be configured as or otherwise support a means for deprioritizing measurements associated with a second network entity that the UE is leaving, based on determining that the UE is approaching the first network entity, where the at least one mobility operation includes the measurement reporting procedure.

In some examples, the measurement reporting manager 1050 may be configured as or otherwise support a means for initiating a timer corresponding to a first measurement report associated with a first network entity of the set of multiple network entities, where the first network entity includes a serving cell for the UE. In some examples, the measurement reporting manager 1050 may be configured as or otherwise support a means for transmitting the first measurement report prior to expiration of the timer based on switching to the high mobility operating mode. In some examples, the measurement reporting manager 1050 may be configured as or otherwise support a means for initiating a timer corresponding to a first measurement report associated with a first network entity of the set of multiple network entities, where the first network entity includes a serving cell for the UE. In some examples, the measurement reporting manager 1050 may be configured as or otherwise support a means for transmitting, prior to expiration of the first measurement report and based on switching to the high mobility operating mode, a second measurement report associated with a second network entity of the set of multiple network entities, where the second network entity includes a neighbor cell for the UE.

In some examples, the scanning manager 1055 may be configured as or otherwise support a means for identifying a radio link failure between the UE and a first network entity of the set of multiple network entities. In some examples, the scanning manager 1055 may be configured as or otherwise support a means for scanning a subset of available frequency resources based on switching to the high mobility operating mode, the subset of available frequency resources based on a cell map associated with the set of multiple network entities, where the at least one mobility operation includes the connection procedure, and where the connection procedure is based on the scanning.

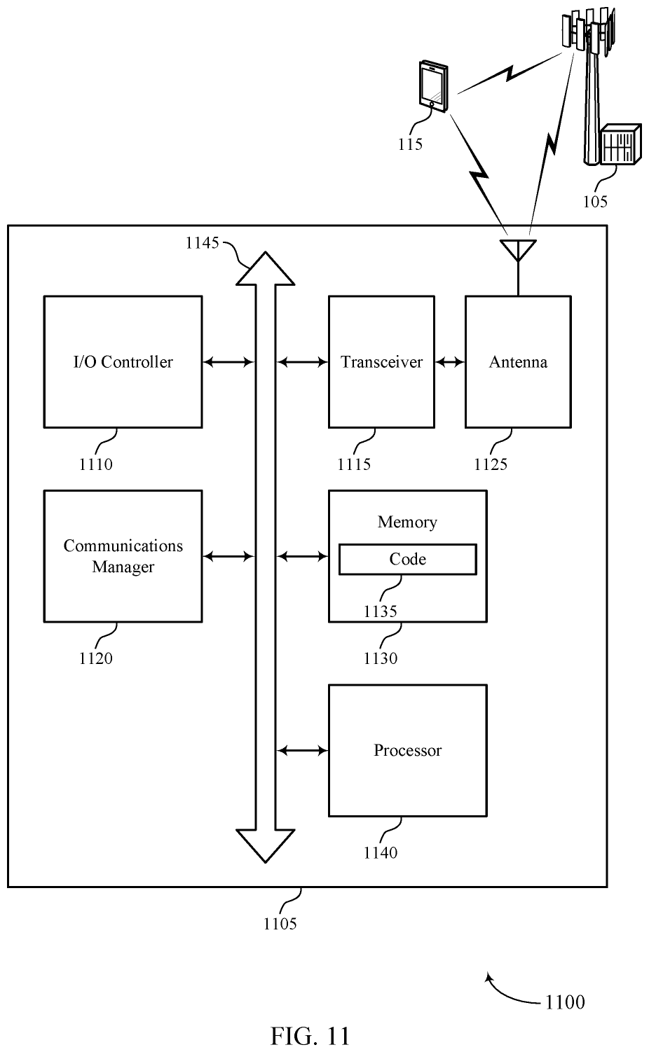

FIG. 11 shows a diagram of a system 1100 including a device 1105 that supports techniques for detecting high mobility and enhancing modem performance in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for detecting high mobility and enhancing modem performance). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communications at a UE in accordance with examples as disclosed herein. For example, the communications manager 1120 may be configured as or otherwise support a means for detecting one or more triggering conditions associated with travel along a route corresponding to a set of multiple network entities. The communications manager 1120 may be configured as or otherwise support a means for switching from a default operating mode to a high mobility operating mode based on detecting the one or more triggering conditions. The communications manager 1120 may be configured as or otherwise support a means for performing at least one mobility operation including a handover procedure, a neighbor cell reselection procedure, a measurement reporting procedure, or a connection procedure, according to the high mobility operating mode.

By including or configuring the communications manager 1120 in accordance with examples as described herein, the device 1105 may support techniques for operating mode switching that may result in decreased system latency, more reliable connections, improved power savings, less time spent in RLF or OOS conditions, more efficient use of computational resources, and improved user experience.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for detecting high mobility and enhancing modem performance as described herein, or the processor 1140 and the memory 1130 may be otherwise configured to perform or support such operations.

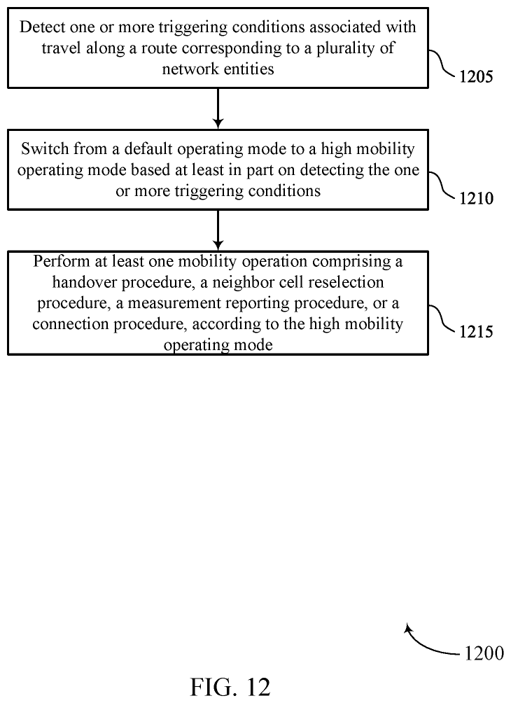

FIG. 12 shows a flowchart illustrating a method 1200 that supports techniques for detecting high mobility and enhancing modem performance in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include detecting one or more triggering conditions associated with travel along a route corresponding to a set of multiple network entities. The operations of 1205 may be performed in accordance with examples as disclosed herein. In some examples, aspects of the operations of 1205 may be performed by a triggering condition manager 1025 as described with reference to FIG. 10.

At 1210, the method may include switching from a default operating mode to a high mobility operating mode based on detecting the one or more triggering conditions. The operations of 1210 may be performed in accordance with examples as disclosed herein. In some examples, aspects of the operations of 1210 may be performed by an operating mode manager 1030 as described with reference to FIG. 10.

At 1215, the method may include performing at least one mobility operation including a handover procedure, a neighbor cell reselection procedure, a measurement reporting procedure, or a connection procedure, according to the high mobility operating mode. The operations of 1215 may be performed in accordance with examples as disclosed herein. In some examples, aspects of the operations of 1215 may be performed by a mobility operation manager 1035 as described with reference to FIG. 10.

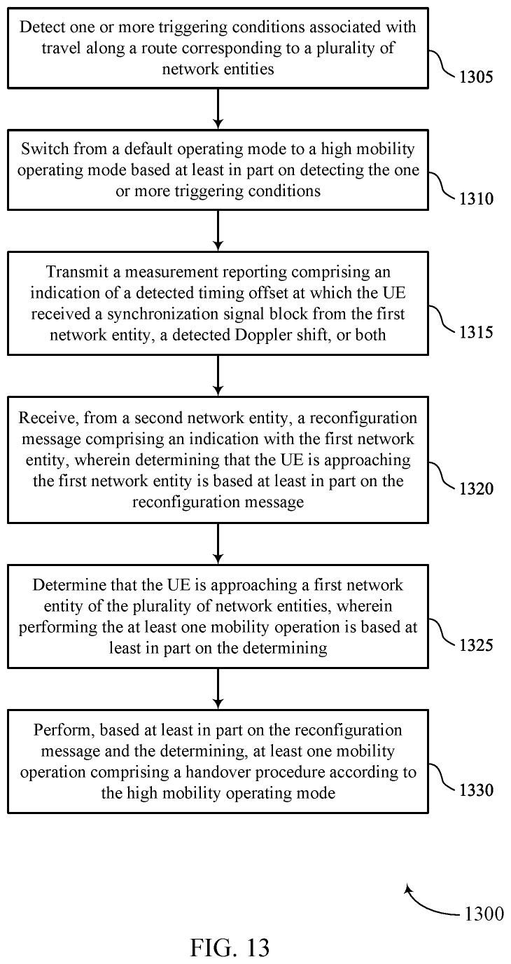

FIG. 13 shows a flowchart illustrating a method 1300 that supports techniques for detecting high mobility and enhancing modem performance in accordance with one or more aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include detecting one or more triggering conditions associated with travel along a route corresponding to a set of multiple network entities. The operations of 1305 may be performed in accordance with examples as disclosed herein. In some examples, aspects of the operations of 1305 may be performed by a triggering condition manager 1025 as described with reference to FIG. 10.

At 1310, the method may include switching from a default operating mode to a high mobility operating mode based on detecting the one or more triggering conditions. The operations of 1310 may be performed in accordance with examples as disclosed herein. In some examples, aspects of the operations of 1310 may be performed by an operating mode manager 1030 as described with reference to FIG. 10.

At 1315, the method may include transmitting a measurement reporting including an indication of a detected timing offset at which the UE received a synchronization signal block from the first network entity, a detected Doppler shift, or both. The operations of 1315 may be performed in accordance with examples as disclosed herein. In some examples, aspects of the operations of 1315 may be performed by a measurement reporting manager 1050 as described with reference to FIG. 10.

At 1320, the method may include receiving, from a second network entity, a reconfiguration message including an indication with the first network entity. The operations of 1320 may be performed in accordance with examples as disclosed herein. In some examples, aspects of the operations of 1320 may be performed by a measurement reporting manager 1050 as described with reference to FIG. 10.

At 1325, the method may include determining, based at least in part on the reconfiguration message, that the UE is approaching a first network entity of the set of multiple network entities, where performing the at least one mobility operation is based on the determining. The operations of 1325 may be performed in accordance with examples as disclosed herein. In some examples, aspects of the operations of 1325 may be performed by a neighbor cell direction manager 1045 as described with reference to FIG. 10.

At 1330, the method may include performing, based at least in part on the reconfiguration message and the determining, at least one mobility operation comprising a handover procedure with the first network entity according to the high mobility operating mode. The operations of 1330 may be performed in accordance with examples as disclosed herein. In some examples, aspects of the operations of 1330 may be performed by a mobility operation manager 1035 as described with reference to FIG. 10.

The following provides an overview of aspects of the present disclosure:

Aspect 1: A method for wireless communications at a UE, comprising: detecting one or more triggering conditions associated with travel along a route corresponding to a plurality of network entities; switching from a default operating mode to a high mobility operating mode based at least in part on detecting the one or more triggering conditions; and performing at least one mobility operation comprising a handover procedure, a neighbor cell reselection procedure, a measurement reporting procedure, or a connection procedure, according to the high mobility operating mode.

Aspect 2: The method of aspect 1, wherein detecting the one or more triggering conditions comprises: accessing an entrance to the route via an application executed by the UE, wherein the route comprises a subway route, a high-speed train route, a freeway route, or a combination thereof.

Aspect 3: The method of any of aspects 1 through 2, wherein detecting the one or triggering conditions comprises: connecting to a wireless local area network associated with the route.

Aspect 4: The method of any of aspects 1 through 3, wherein detecting the one or more triggering conditions comprises: detecting a sensor input indicating that the UE is located on the route, within a vehicle associated with the route, or both.

Aspect 5: The method of aspect 4, wherein the sensor input comprises: a pressure measurement associated with train car door opening or closing, a pressure measurement associated with entering an underground train station, a motion sensor measurement indicating a vibration pattern, a camera input indicating a lighting environment associated with a train car or train station, a microphone input indicating an acoustic pattern associated with the train car or train station, a magnetic sensor measurement indicating high mobility on a train or subway, a GPS input indication a location along the route, a GPS signal strength that satisfies a threshold signal strength level, or any combination thereof.

Aspect 6: The method of any of aspects 1 through 5, wherein detecting the one or more triggering conditions comprises: detecting a change in reference signal receive power (RSRP) that satisfies a threshold.

Aspect 7: The method of any of aspects 1 through 6, further comprising: communicating with one or more respective network entities of the plurality of network entities one or more times during a time period; confirming an accuracy level of a cell map comprising information associated with the plurality of network entities based at least in part on traveling along the route and communicating with the plurality of network entities at least a threshold number of times; and establishing a connection with a first network entity of the plurality of network entities, wherein detecting the one or more triggering conditions comprises determining that the first network entity is associated with the cell map.

Aspect 8: The method of any of aspects 1 through 7, further comprising: establishing one or more connections with respective network entities of the plurality of network entities one or more times during a time period; submitting an indication of the respective network entities of the plurality of network entities to a cloud server; receiving, from the cloud server based at least in part on submitting the indication of the respective network entities and a current location of the UE within the route, an indication of a cell map comprising information associated with the plurality of network entities; and establishing a connection with a first network entity of the plurality of network entities, wherein detecting the one or more triggering conditions comprises determining that the first network entity is associated with the cell map.

Aspect 9: The method of any of aspects 1 through 8, further comprising: determining that the UE is approaching a first network entity of the plurality of network entities, wherein performing the at least one mobility operation is based at least in part on the determining.

Aspect 10: The method of aspect 9, further comprising: receiving a synchronization signal block from the first network entity prior to expiration of a synchronization signal block periodicity by a timing offset, wherein the determining is based at least in part on the receiving.

Aspect 11: The method of any of aspects 9 through 10, further comprising: detecting a positive Doppler shift based at least in part on a frequency tracking loop, wherein the determining is based at least in part on detecting the positive Doppler shift.

Aspect 12: The method of any of aspects 9 through 11, further comprising: transmitting a measurement reporting comprising an indication of a detected timing offset at which the UE received a synchronization signal block from the first network entity, a detected Doppler shift, or both; receiving, from a second network entity, a reconfiguration message comprising an indication with the first network entity, wherein determining that the UE is approaching the first network entity is based at least in part on the reconfiguration message; and performing the handover procedure with the first network entity based at least in part on the reconfiguration message, wherein the at least one mobility operation comprises the handover procedure.

Aspect 13: The method of any of aspects 9 through 12, further comprising: building a cell map comprising information associated with the plurality of network entities based at least in part on communicating with respective network entities of the plurality of network entities; determining a moving direction along the route based at least in part on the cell map, wherein determining that the UE is approaching the first network entity is based at least in part on the moving direction and the cell map.

Aspect 14: The method of any of aspects 9 through 13, further comprising: disabling the at least one mobility operation for a second network entity that the UE is leaving, based at least in part on determining that the UE is approaching the first network entity.

Aspect 15: The method of any of aspects 9 through 14, further comprising: deprioritizing measurements associated with a second network entity that the UE is leaving, based at least in part on determining that the UE is approaching the first network entity, wherein the at least one mobility operation comprises the measurement reporting procedure.

Aspect 16: The method of any of aspects 1 through 15, further comprising: initiating a timer corresponding to a first measurement report associated with a first network entity of the plurality of network entities, wherein the first network entity comprises a serving cell for the UE; and transmitting the first measurement report prior to expiration of the timer based at least in part on switching to the high mobility operating mode.

Aspect 17: The method of any of aspects 1 through 16, further comprising: initiating a timer corresponding to a first measurement report associated with a first network entity of the plurality of network entities, wherein the first network entity comprises a serving cell for the UE; transmitting, prior to expiration of the first measurement report and based at least in part on switching to the high mobility operating mode, a second measurement report associated with a second network entity of the plurality of network entities, wherein the second network entity comprises a neighbor cell for the UE.

Aspect 18: The method of any of aspects 1 through 17, further comprising: identifying a radio link failure between the UE and a first network entity of the plurality of network entities; scanning a subset of available frequency resources based at least in part on switching to the high mobility operating mode, the subset of available frequency resources based at least in part on a cell map associated with the plurality of network entities, wherein the at least one mobility operation comprises the connection procedure, and wherein the connection procedure is based at least in part on the scanning.

Aspect 19: An apparatus for wireless communications at a UE, comprising a processor; memory coupled with the processor; and instructions stored in the memory and executable by the processor to cause the apparatus to perform a method of any of aspects 1 through 18.

Aspect 20: An apparatus for wireless communications at a UE, comprising at least one means for performing a method of any of aspects 1 through 18.

Aspect 21: A non-transitory computer-readable medium storing code for wireless communications at a UE, the code comprising instructions executable by a processor to perform a method of any of aspects 1 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
detect one or more triggering conditions associated with travel along a route corresponding to a plurality of network entities;
switch from a default operating mode to a high mobility operating mode based at least in part on detecting the one or more triggering conditions; and
perform at least one mobility operation comprising a handover procedure, a neighbor cell reselection procedure, a measurement reporting procedure, or a connection procedure, according to the high mobility operating mode.

2. The apparatus of claim 1, wherein the instructions to detect the one or more triggering conditions are executable by the processor to cause the apparatus to:
access an entrance to the route via an application executed by the UE, wherein the route comprises a subway route, a high-speed train route, a freeway route, or a combination thereof.

3. The apparatus of claim 1, wherein the instructions to detect the one or triggering conditions are executable by the processor to cause the apparatus to:
connect to a wireless local area network associated with the route.

4. The apparatus of claim 1, wherein the instructions to detect the one or more triggering conditions are executable by the processor to cause the apparatus to:
detect a sensor input indicating that the UE is located on the route, within a vehicle associated with the route, or both.

5. The apparatus of claim 4, wherein the instructions to sensor input are executable by the processor to cause the apparatus to:
a pressure measurement associate with train car door opening or closing, a pressure measurement associated with entering an underground train station, a motion sensor measurement indicating a vibration pattern, a camera input indicating a lighting environment associated with a train car or train station, a microphone input indicating an acoustic pattern associated with the train car or train station, a magnetic sensor measurement indicating high mobility on a train or subway, a GPS input indication a location along the route, a GPS signal strength that satisfies a threshold signal strength level, or any combination thereof.

6. The apparatus of claim 1, wherein the instructions to detect the one or more triggering conditions are executable by the processor to cause the apparatus to:
detect a change in reference signal receive power (RSRP) that satisfies a threshold.

7. The apparatus of claim 1, wherein the instructions are further executable by the processor to cause the apparatus to:
communicate with one or more respective network entities of the plurality of network entities one or more times during a time period;
confirm an accuracy level of a cell map comprising information associated with the plurality of network entities based at least in part on traveling along the route and communicating with the plurality of network entities at least a threshold number of times; and
establish a connection with a first network entity of the plurality of network entities, wherein detecting the one or more triggering conditions comprises determining that the first network entity is associated with the cell map.

8. The apparatus of claim 1, wherein the instructions are further executable by the processor to cause the apparatus to:
establish one or more connections with respective network entities of the plurality of network entities one or more times during a time period;
submit an indication of the respective network entities of the plurality of network entities to a cloud server;
receive, from the cloud server based at least in part on submitting the indication of the respective network entities and a current location of the UE within the route, an indication of a cell map comprising information associated with the plurality of network entities; and
establish a connection with a first network entity of the plurality of network entities, wherein detecting the one or more triggering conditions comprises determining that the first network entity is associated with the cell map.

9. The apparatus of claim 1, wherein the instructions are further executable by the processor to cause the apparatus to:
determine that the UE is approaching a first network entity of the plurality of network entities, wherein performing the at least one mobility operation is based at least in part on the determining.

10. The apparatus of claim 9, wherein the instructions are further executable by the processor to cause the apparatus to:
receive a synchronization signal block from the first network entity prior to expiration of a synchronization signal block periodicity by a timing offset, wherein the determining is based at least in part on the receiving.

11. The apparatus of claim 9, wherein the instructions are further executable by the processor to cause the apparatus to:
detect a positive Doppler shift based at least in part on a frequency tracking loop, wherein the determining is based at least in part on detecting the positive Doppler shift.

12. The apparatus of claim 9, wherein the instructions are further executable by the processor to cause the apparatus to:
transmit a measurement reporting comprising an indication of a detected timing offset at which the UE received a synchronization signal block from the first network entity, a detected Doppler shift, or both;
receive, from a second network entity, a reconfiguration message comprising an indication with the first network entity, wherein determining that the UE is approaching the first network entity is based at least in part on the reconfiguration message; and
perform the handover procedure with the first network entity based at least in part on the reconfiguration message, wherein the at least one mobility operation comprises the handover procedure.

13. The apparatus of claim 9, wherein the instructions are further executable by the processor to cause the apparatus to:
build a cell map comprising information associated with the plurality of network entities based at least in part on communicating with respective network entities of the plurality of network entities; and
determine a moving direction along the route based at least in part on the cell map, wherein determining that the UE is approaching the first network entity is based at least in part on the moving direction and the cell map.

14. The apparatus of claim 9, wherein the instructions are further executable by the processor to cause the apparatus to:
disable the at least one mobility operation for a second network entity that the UE is leaving, based at least in part on determining that the UE is approaching the first network entity.

15. The apparatus of claim 9, wherein the instructions are further executable by the processor to cause the apparatus to:
deprioritize measurements associated with a second network entity that the UE is leaving, based at least in part on determining that the UE is approaching the first network entity, wherein the at least one mobility operation comprises the measurement reporting procedure.

16. The apparatus of claim 1, wherein the instructions are further executable by the processor to cause the apparatus to:
initiate a timer corresponding to a first measurement report associated with a first network entity of the plurality of network entities, wherein the first network entity comprises a serving cell for the UE; and
transmit the first measurement report prior to expiration of the timer based at least in part on switching to the high mobility operating mode.

17. The apparatus of claim 1, wherein the instructions are further executable by the processor to cause the apparatus to:
initiate a timer corresponding to a first measurement report associated with a first network entity of the plurality of network entities, wherein the first network entity comprises a serving cell for the UE; and
transmit, prior to expiration of the first measurement report and based at least in part on switching to the high mobility operating mode, a second measurement report associated with a second network entity of the plurality of network entities, wherein the second network entity comprises a neighbor cell for the UE.

18. The apparatus of claim 1, wherein the instructions are further executable by the processor to cause the apparatus to:
identify a radio link failure between the UE and a first network entity of the plurality of network entities; and
scan a subset of available frequency resources based at least in part on switching to the high mobility operating mode, the subset of available frequency resources based at least in part on a cell map associated with the plurality of network entities, wherein the at least one mobility operation comprises the connection procedure, and wherein the connection procedure is based at least in part on the scanning.

19. A method for wireless communications at a user equipment (UE), comprising:
detecting one or more triggering conditions associated with travel along a route corresponding to a plurality of network entities;
switching from a default operating mode to a high mobility operating mode based at least in part on detecting the one or more triggering conditions; and
performing at least one mobility operation comprising a handover procedure, a neighbor cell reselection procedure, a measurement reporting procedure, or a connection procedure, according to the high mobility operating mode.

20. A non-transitory computer-readable medium storing code for wireless communications at a user equipment (UE), the code comprising instructions executable by a processor to:
detect one or more triggering conditions associated with travel along a route corresponding to a plurality of network entities;
switch from a default operating mode to a high mobility operating mode based at least in part on detecting the one or more triggering conditions; and
perform at least one mobility operation comprising a handover procedure, a neighbor cell reselection procedure, a measurement reporting procedure, or a connection procedure, according to the high mobility operating mode.
